(19) United States
(12) Patent Application Publication
(10) Pub. No.: US 2019/0153781 A1
(43) Pub. Date: May 23, 2019

(54) Window Escape Ladder

(71) Applicants: Eric Hartsfield, Suffolk, VA (US); Brett Russell, Norfolk, VA (US); Francis Hauris, Plscataway, NJ (US)

(72) Inventors: Eric Hartsfield, Suffolk, VA (US); Brett Russell, Norfolk, VA (US); Francis Hauris, Plscataway, NJ (US)

(21) Appl. No.: 15/820,581

(22) Filed: Nov. 22, 2017

(51) Int. Cl. E06C 9/14; E06C 1/56

(52) U.S. Cl. CPC E06C 9/14; E05Y 2900/148; E06C 1/56

(57) ABSTRACT

A window frame assembly incorporating a structure for containing an emergency ladder, the ladder contained within a compartment in the lower portion of the window frame assembly. The ladder is connected directly to the structure of a building by a structural attachment, the structural attachment having connection points so that the weight of a user of the ladder is supported by the building structure. The compartment opens into the living or working area of a building, and has a removable cover. The window assembly is installed as a unit once the structural attachment is affixed to a building structural member in the bottom of the framed window opening.

### FIELD OF THE INVENTION

The invention described herein relates to window construction and more specifically to escape ladders for windows.

### BACKGROUND OF THE INVENTION

Having readily accessible escape routes from a home in the case of fire or other emergency can make the difference between life and death. It is not simply fires that are of concern. Having an escape ladder available for children and other members of a family can provide safe and simple egress in the case of home invasion, gas leaks, and other situations that require quick exit of a building other than through the doors. Numerous attempts to incorporate escape ladders for two- and more story homes in windows have been attempted in the past, but each has drawbacks leaving a need for a new solution to emergency building egress.

In U.S. Pat. No. 4,445,889 to Longenecker for a Window Assembly Including a Storable Fire Escape, issued May 1, 1984 (the “'889” patent), a window assembly with a fire escape ladder contained within a compartment under a swing-out window is disclosed. The ladder is attached to a pipe within the compartment, and the entire window assembly is swung out and away from the house prior to pulling out the ladder and dropping it to the ground. There are several drawbacks to this design. First, swinging the entire window assembly out and away from the building is not a normal window operation. During an emergency, remembering how to operate the window to use the fire escape ladder could cause significant and life-threatening delays in being able to escape the building. In addition, the storage compartment is on the side of the window away from the user, thereby making it difficult to see the ladder while deploying it. And the swing-out design of the window assembly creates vulnerability to moisture damage around the swing-out mechanism. By its very nature, the device creates a large opening to seal increasing maintenance and moisture concerns. Finally, the pipe is attached to the frame members of the window itself, rather than to the underlying structure of the house, reducing the load that the device is capable of holding and introducing the risk of mechanical failure.

U.S. Pat. No. 5,467,841 to Krumal for an Escape Window Frame Assembly, issued Nov. 21, 1995 (the “'841” patent), suffers from similar flaws as the '889 patent. The '841 patent further complicates exiting the window in an emergency by requiring a user to exert enough force outwardly on the window to break a shear pin before the window can swing outward and allow egress. This is a significant drawback to the design, in that it is of significant concern that small children be able to utilize an escape system. Requiring a child to remember how to operate the '841 and '889 patent designs adds complexity to the means of escape that is unnecessary and dangerous. Additionally, a child attempting to operate the '841 invention would be required to exert enough force to break a shear pin before being able to exit the building.

U.S. Pat. No. 5,971,105 to Jacobson for an Escape Ladder, issued Oct. 26, 1999 (the “'105” patent) teaches an escape ladder stored in an interior wall of a building, beneath a window. The '105 invention teaches modifications to an existing structure, with a storage container mounted flush or recessed to the interior wall of a building beneath a window. The '105 invention, however, is not integral to the window itself, adding complicating steps to the installation of the device in new construction. Further, the '105 invention is a separate device from a window assembly, so that it cannot be provided as an integral part of a replacement window structure without being installed separately.

U.S. Pat. No. 6,102,155 to Hood et al. for a Combined Window and Emergency Escape Ladder, issued Aug. 15, 2000 (the “'155” patent) teaches an escape ladder stored in an interior wall of a building, beneath a window. In particular, the ladder storage is positioned within a window frame with a portion of the window sill being removed in order to deploy the ladder. The '155 invention, however, is undesirable in that it introduces an opening (the top of the storage) in the window sill itself, with a cover positioned over the opening. This configuration creates a significant risk of water leakage and damage into the structural portion of the house underneath the window sill, an area that is already at significant risk for water damage if not sealed adequately against the weather. In addition to the extra unwanted water exposure, that additional exposure increases the risk of structural failure around and particularly underneath the window, destabilizing the house and window, thereby increasing the risk of the failure of the escape ladder in the event that it needs to be used. Finally, a configuration for storage of an escape ladder underneath a window with the opening in the window sill makes it difficult to access the storage and ladder for inspection and repair, thereby hampering maintenance and increasing the risk of failure of the ladder in the event it is used.

U.S. Pat. No. 6,845,844 to Williams for a Fire Escape Apparatus, issued Jan. 25, 2005 (the “'844” patent) teaches a fire escape ladder apparatus that is intended to be built into the structure of a building. The '844 patent suffers from a similar drawback to the '155 patent in that the '844 apparatus requires an opening in the window sill, thus exposing the house and window structure to the same potential water damage and structural failure as the '155 patent. Further, the '844 apparatus requires significant structural changes to a building to install. Finally, access to the '844 apparatus for inspection and repair is hampered by the location and vertical storage.

The same flaws in the '155 and '844 inventions are inherent in U.S. Pat. No. 7,004,287 to Barbara for a Hidden Fire Escape, issued Feb. 28, 2006 (the “'287” patent). As with the '155 and '844 inventions, the '287 patent teaches a storage for an escape ladder positioned under the window sill, with the opening for use of the ladder located in the window sill itself which, as noted above, is highly undesirable and can create additional risks for the user.

U.S. Pat. Nos. 4,595,075, 6,382,352, and 8,162,105 teach escape ladders attached the exterior of structures, adding unsightly devices to the exteriors of buildings as well as exposing the escape apparatus to the weather, increasing the likelihood of failure when used.

Additionally, exterior and escape ladders with hidden or out-of-sight access increases the risk of a user, especially a child, either not thinking of the available escape ladder or being able to find it during the panic involved with trying to escape a life-threatening emergency.

### BRIEF SUMMARY OF THE PRESENT DISCLOSURE

It is important to provide the maximum possible load bearing for the escape ladder and reduce the possibility of failure due to overloading the ladder. This is best accomplished by affixing the ladder to the structure of the building rather than the structure of the window. The prior art does not provide a simple but effective means of attaching the escape ladder to the strong structural framework of a building.

There have been numerous attempts to perfect a method and device for providing egress from a window in a building to escape from fire or other potential life-threatening circumstances. No prior effort, however, provides the benefits attendant with the present invention. Additionally, the prior patents and commercial techniques do not suggest the present inventive combination of component elements arranged and configured as disclosed and claimed herein.

What is needed is a building window escape ladder that is integral with a window and frame structure that can be provided as a single unit, and mounted within window openings in new and old construction. The device should not create any additional weather exposure to the window or underlying structure. The device should also be aesthetically pleasing, but visible at all times and easily identified and accessed during an emergency that requires escape through a window rather than a door.

It is therefore an object of the present invention to provide a window that includes an integral escape ladder.

It is a further object of the present invention to provide a window that includes an integral escape ladder, the window being configured such that it can be installed in new construction in a similar manner as currently available window frame assemblies that are installed in new construction buildings.

It is a further object of the present invention to provide a window that includes an integral escape ladder, the window being configured such that it can be installed as a replacement window in existing structures.

It is a further object of the present invention to provide a window that includes an integral escape ladder, the window being configured such that it does not create additional risk for water leakage above that of current window construction.

It is a further object of the present invention to provide a window that includes an integral escape ladder, the escape ladder being affixed to the structure of the building rather than the structure of the window, providing the greatest load-bearing possible.

It is a further object of the present invention to provide a window that includes an integral escape ladder, the window being configured such that the escape ladder is easily accessible for use, inspection, maintenance, repair, and replacement.

It is a further object of the present invention to provide a window that includes an integral escape ladder, the window being configured such that access to the escape ladder is visible and readily identifiable at all times such that it is easily identified and accessed in the event of an emergency.

These and other embodiments are described by the following figures and detailed description.

### BRIEF DESCRIPTION OF THE DRAWINGS

FIG. 1 is a view of an embodiment of the present invention showing the lower portion of the window assembly in accordance with an embodiment of the present invention.

FIG. 2 is a view of an embodiment of the present invention showing the lower portion of the window assembly and the cover to the escape ladder storage open in accordance with an embodiment of the present invention.

FIG. 3 is a view of an embodiment of the present invention showing the window assembly in accordance with an embodiment of the present invention.

FIG. 4 is a view of an embodiment of the present invention showing the lower portion of the window assembly in accordance with an embodiment of the present invention.

FIG. 5 is a view of an embodiment of the present invention showing a structural attachment and structural support in accordance with an embodiment of the present invention.

FIG. 6 is a view of an embodiment of the present invention showing the exterior of a structure and the escape ladder of the present invention deployed for use.

### DETAILED DESCRIPTION OF THE INVENTION

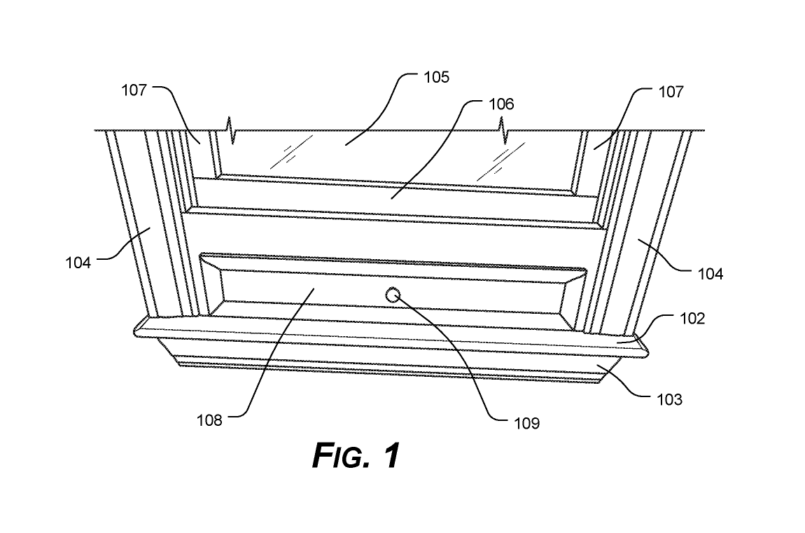

Referring now to FIG. 1, a bottom portion of a window 101 is shown. The stool 102 and the apron 103 are shown, as well as the inside casing 104, and the lower portion of the window 105, the rail 106, and the lower portions of the stiles 107. Also shown is a cover 108 with a knob 109. The cover 108, when removed, reveals a compartment located within the lower portion of the window 101. FIG. 1 and the remaining Figures herein show the invention as seen from the interior of a structure. The cover 108 can have lights, audible alarms, smoke and other detectors. It will also be understood that the cover 108 can be equipped with a removal alert system, allowing alerts (audible, text or other mobile alerts, etc.) to be sent when the cover 108 is removed, whether in an emergency or otherwise.

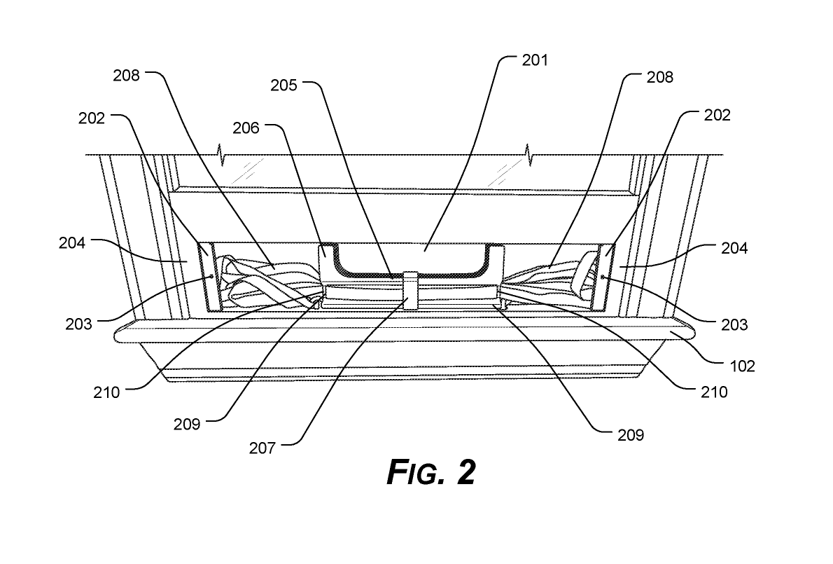

Referring now to FIG. 2, the bottom portion of the window 101 is shown as in FIG. 1, but with the cover (FIG. 1, 108) removed from the window 101. A compartment 201 is contained within the bottom of the window 101 on top of the stool 102. Brackets 202 with retaining holes 203 are positioned at opposite ends 204 of the compartment 201, the retaining holes 203 within the brackets 202 correspond to retaining pins (not shown) located on the back portion of the cover 108. It will be understood that there are various fastening means available to hold the cover 108 in place, the pin and hole construction utilized herein are for ease of removal of the cover in emergencies but should not be construed to be limiting. Any retention means that holds the cover in place while allowing it to be easily removed with little effort may be utilized without deviating from the scope of the invention. Such retention means may include using one or more hinges such that the cover may be opened yet still remain attached to the window structure. It will be understood that the compartment has a single open side that is revealed by removing the cover. The compartment is otherwise enclosed with a top portion, two side portions, and a base. The open side is positioned to face the interior of a building and away from the exterior of a building.

The compartment 201 contains a ladder 205, consisting of rungs 206, straps 208 connecting the rungs 206 at the ends 209 of the rungs 206. The straps 208 pass through slots 210 in the rungs 206, such that the straps 208 are positioned under the rungs 206 when the ladder 205 is in use, providing weight-bearing support for the rungs 206. While contained within the compartment 201, the rungs 206 are stacked and held together as a bundle by a restraining means 207, such as hook-and-loop fastening (Velcro®) or the like.

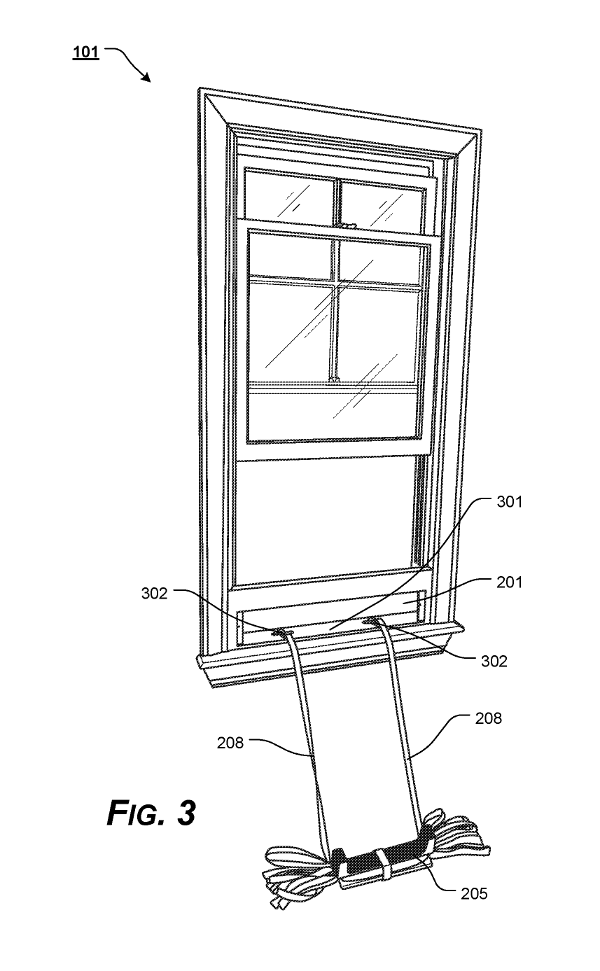

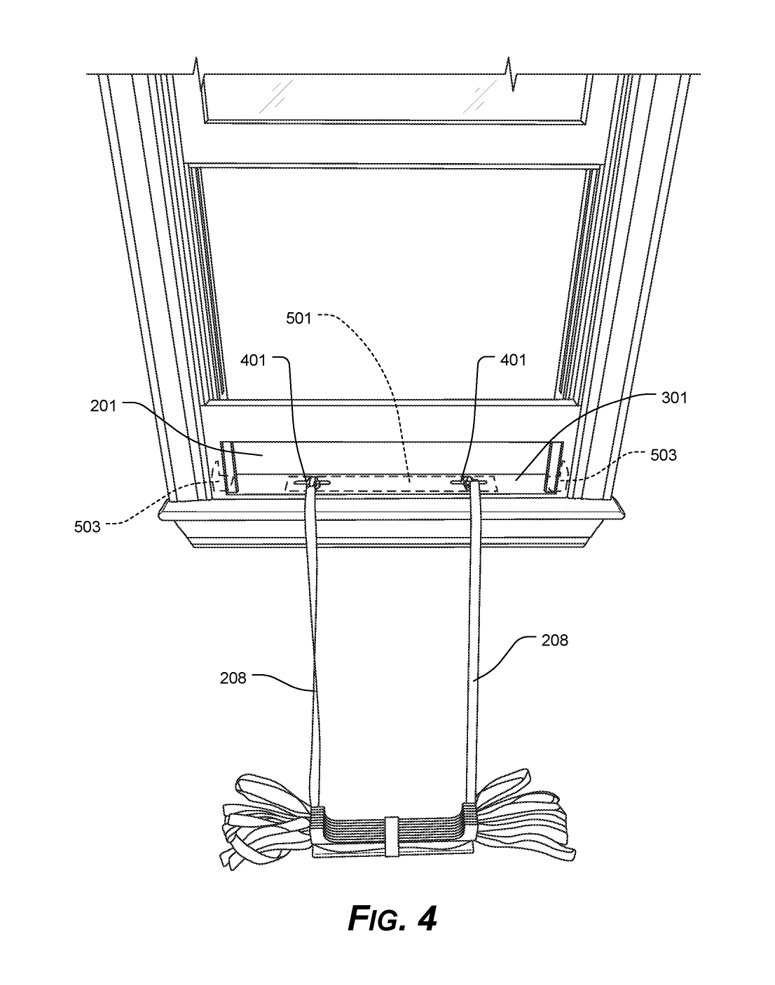

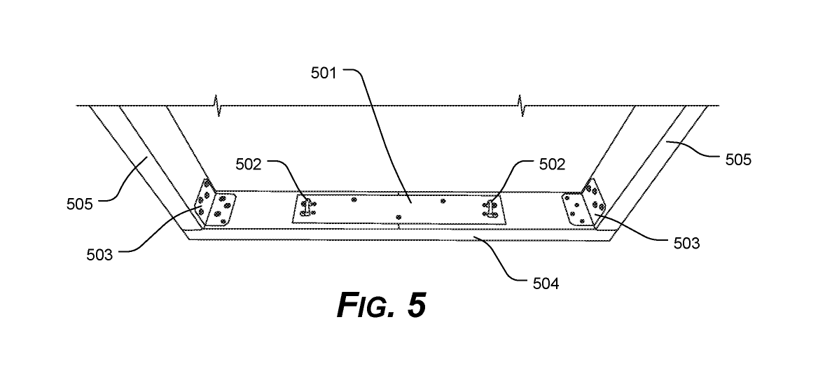

Referring now to FIG. 3, the present invention is shown with the ladder 205 having been pulled out of the compartment 201. The straps 208 terminate in fasteners 302 that are attached to fastening points (FIG. 5, 502), the fastening points located at the base 301 of the compartment. As shown in FIG. 4, at the base 301 of the compartment 201 the fastening points (FIG. 5, 502) extend through openings 401 in the base of the compartment 201. It will be understood that the openings 401 may be of different shapes and sizes, only limited by the ability of the fastening points to extend through the openings 401. It will also be understood that the openings and fastening points may also be positioned on the sides of the compartment. The fastening points are physically incorporated into a structural attachment (FIG. 5, 501) further described below. The structural attachment 501 and additional structural supports (FIG. 5, 503) are shown in FIG. 4 through dotted lines, indicating their position underneath and to the side of the compartment assembly. When in use, the ladder is removed from the compartment 201, the restraining means 207 is removed from the rungs 206, and the ladder 205 is then moved through the open window and lowered down the outside of the structure.

Referring now to FIG. 5, a portion of the structural opening into which the window 101 is mounted is shown. The structural attachment 501 incorporating fastening points 502 is mechanically affixed to the lower structural member 504 of the structural opening for the window 101. Additional structural supports 503 are mechanically affixed to the lower structural member 504 and the vertical structural members 505 of the structural opening. The structural attachment 501 and the additional structural supports 503 are installed prior to the window 101 being installed in the structural opening, with the window 101 being placed within the structural opening such that the fastening points 502 extend up through the openings (FIG. 4, 401) in the base (FIG. 4, 301) of the compartment (FIG. 4, 201). In this manner, when the ladder is being used, the weight of individuals on the ladder is being carried by the structural framing of the building itself, rather than relying upon the weaker structure of the window assembly. It will be understood that the structural attachment and additional structural supports may be of separate pieces as shown, or may be constructed of a single, adjustable apparatus such that any size window opening may be accommodated. The structural attachment 501 may comprise a single structure, or may comprise well-known attaching means such as mechanical fasteners including lag bolts, carriage bolts, hook eyes, eye-bolts, welded fasteners, and the like. The structural attachment 501 as shown herein will accommodate any size window opening.

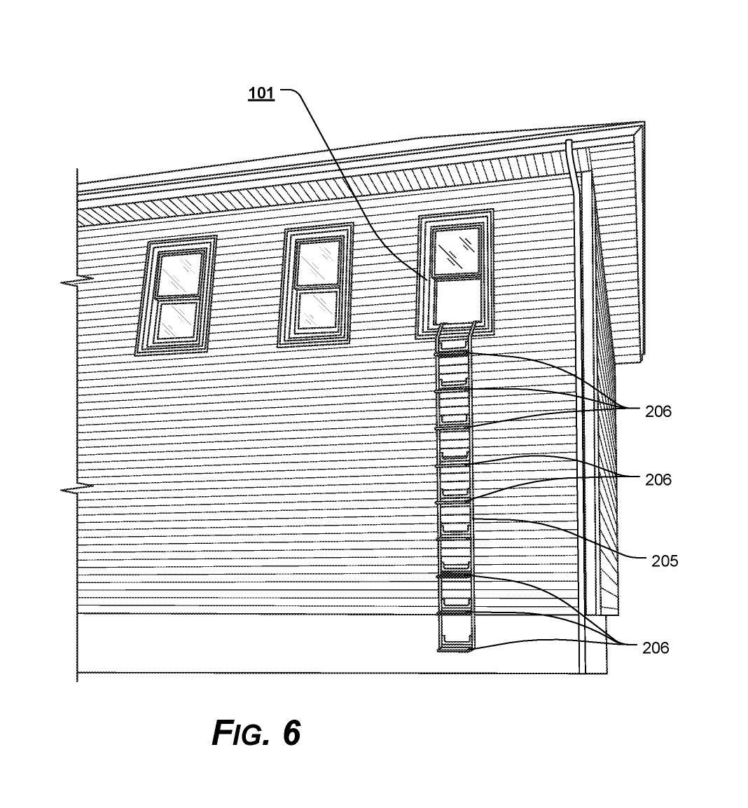

FIG. 6 shows the exterior of a structure and the escape ladder of the present invention deployed for use.

The invention as described herein should not be construed as limiting, and there are modifications that would be obvious to one skilled in the art that fall within the scope of the invention. It will also be understood that the window as shown herein may be constructed of any proper material, including but not limited to wood, metal, or plastic. It will also be understood that, while the invention as described herein shows a ladder with rungs and straps, that should not be considered limiting. The present invention may be utilized with other escape means, such as ropes, rope ladders, cables, webbing, cargo nets, and other means of egress from a window to the outside of a structure without changing the scope and nature of the invention.

1-26. (canceled)

27. A window frame assembly for installation in a structural opening, comprising:
at least one structural attachment configured to be attached or coupled to a structural member of said structural opening, wherein said at least one structural attachment comprises a structural attachment plate, and wherein said structural attachment includes one or more fastening points;
a compartment formed as a portion of said window frame assembly, wherein said compartment includes one or more openings formed therethrough, wherein one or more of said openings formed therethrough is/are formed so as to align with at least a portion of one of said one or more fastening points, and wherein at least a portion of one of said one or more fastening points is accessible through a corresponding one of said openings; and
a ladder comprising a plurality of rungs attached or coupled at spaced apart locations along one or more straps, wherein said one or more straps extend from one or more terminal ends, wherein said one or more terminal ends are attached or coupled to said fastening points, and wherein said plurality of rungs and one or more straps are capable of being contained within said compartment.

28. The window frame assembly of claim 27, wherein said structural opening forms an opening for a window.

29. The window frame assembly of claim 27, wherein said compartment is formed within a bottom portion of said window frame assembly.

30. The window frame assembly of claim 27, wherein said compartment is formed in a portion of said window frame assembly.

31. The window frame assembly of claim 27, wherein said compartment is defined at least between a top portion, two side portions, and a base.

32. The window frame assembly of claim 27, wherein said compartment defines an open side.

33. The window frame assembly of claim 32, further comprising a cover, wherein said cover is formed so as to be removably attached or coupled to said open side of said compartment.

34. The window frame assembly of claim 27, wherein said compartment defines an open side, wherein said open side is positioned so as to face an interior of a building.

35. The window frame assembly of claim 27, wherein said one or more terminal ends are attached or coupled to said fastening points.

36. The window frame assembly of claim 27, wherein if said plurality of rungs and one or more straps are contained within said compartment, said plurality of rungs are stacked and held together by a restraining means.

37. A window frame assembly for installation in a structural opening, comprising:
at least one structural attachment configured to be attached or coupled to a structural member of said structural opening, wherein said at least one structural attachment comprises a structural attachment plate, and wherein said structural attachment includes one or more fastening points attached or coupled to said structural attachment;
a compartment formed as a portion of said window frame assembly and defining an open side, wherein said compartment includes one or more openings formed therethrough, wherein one or more of said openings formed therethrough is/are formed so as to align with at least a portion of one of said one or more fastening points, and wherein at least a portion of one of said one or more fastening points is accessible through a corresponding one of said openings; and
a ladder, wherein at least a portion of said ladder is attached or coupled to at least one of said one or more fastening points, and wherein said ladder is capable of being contained within said compartment.

38. The window frame assembly of claim 37, wherein said open side is positioned so as to face an interior of a building.

39. The window frame assembly of claim 37, further comprising a cover, wherein said cover is formed so as to be removably attached or coupled to said open side of said compartment.

40. The window frame assembly of claim 37, wherein said structural opening forms an opening for a window.

41. The window frame assembly of claim 37, wherein said compartment is formed within a bottom portion of said window frame assembly.

42. A window frame assembly for installation in a structural opening, comprising:
at least one structural attachment configured to be attached or coupled to a structural member of said structural opening, wherein said at least one structural attachment comprises a structural attachment plate, and wherein said structural attachment includes one or more fastening points;
a compartment formed as a portion of said window frame assembly and defining an open side, wherein said compartment includes one or more openings formed therethrough, wherein one or more of said openings formed therethrough is/are formed so as to align with at least a portion of one of said one or more fastening points, and wherein at least a portion of at least one of said one or more fastening points is accessible through a corresponding one of said openings; and
a ladder, wherein at least a portion of said ladder is attached or coupled to at least one of said one or more fastening points, and wherein said ladder is capable of being contained within said compartment.

43. The window frame assembly of claim 42, wherein said open side is positioned so as to face an interior of a building.

44. The window frame assembly of claim 42, further comprising a cover, wherein said cover is formed so as to be removably attached or coupled to said open side of said compartment.

45. The window frame assembly of claim 42, wherein said structural opening forms an opening for a window.

46. The window frame assembly of claim 42, wherein said compartment is formed within a bottom portion of said window frame assembly.
